(19) United States
(12) Patent Application Publication
(10) Pub. No.: US 2020/0264360 A1
(43) Pub. Date: Aug. 20, 2020

(54) DISPLAY DEVICE

(71) Applicant: Flexenable Limited, Cambridge (GB)

(72) Inventors: James Harding, Cambridge (GB); Charlotte Harrison, Cambridge (GB)

(21) Appl. No.: 16/651,566

(22) PCT Filed: Sep. 26, 2018
(86) PCT No.: PCT/EP2018/076102

§ 371 Date: Mar. 27, 2020

(30) Foreign Application Priority Data
Sep. 29, 2017 (GB) 1715796.7

(51) Int. Cl. F21V 8/00

(52) U.S. Cl. CPC G02B 6/005; G02B 6/0045; G02B 6/0061; G02B 6/0035

(57) ABSTRACT

A display device, comprising: a control component for electrically controlling the intensity of light transmitted therethrough from a backlight; and an optical component between said backlight and said control component configured to convert input light exhibiting at least one directional property substantially uniformly across an area at an input side of the optical component to output light exhibiting a substantial variation in said at least one directional property across a corresponding area at an output side of the optical component.

Display devices may comprise an optical control component through which the transmission of light from a backlight can be electrically controlled. For example, the optical control component may comprise a liquid crystal cell comprising a uniform thickness of liquid crystal material between orthogonal polarisers, and e.g. electrical circuitry for controlling the molecular alignment, and thus the optical properties of the liquid crystal material in each pixel region.

Display devices are typically flat in configuration, but the inventors for the present application have conducted work into improving the performance of non-flat displays.

There is hereby provided a display device, comprising: a control component for electrically controlling the intensity of light transmitted therethrough from a backlight; and an optical component between said backlight and said control component configured to convert input light exhibiting at least one directional property substantially uniformly across an area at an input side of the optical component to output light exhibiting a substantial variation in said at least one directional property across a corresponding area at an output side of the optical component.

According to one embodiment, said at least one directional property comprises the angular luminance distribution relative to the local normal.

According to one embodiment, said at least one directional property comprises the centre angle of the angular luminance distribution relative to the local normal, or the angle of maximum luminance relative to the local normal.

According to one embodiment, the device is further configured to convert input light exhibiting a relative low directionality substantially uniformly across said area at said input side to output light exhibiting a relatively high directionality substantially uniformly across said corresponding area at an output side.

According to one embodiment, the device is further configured to convert input light exhibiting a relative large full width at half maximum (FWHM) of the angular luminance distribution at said input side to output light exhibiting a relatively small full width at half maximum (FWHM) of the angular luminance distribution at said output side.

According to one embodiment, at least said backlight and said control component are curved in a first region, and wherein said optical component is configured to convert input light exhibiting a substantially uniform luminance distribution relative to a local normal across an input side area corresponding to said first region to output light exhibiting a substantially uniform luminance distribution relative to a common reference direction, across a corresponding output side area corresponding to said first region.

According to one embodiment, said optical component comprises microstructures defined in an output surface of a light guide, wherein the optical action of said microstructures varies across the area of said output surface.

Embodiments of the invention are described in detail hereunder, by way of example only, with reference to the accompanying drawings, in which:

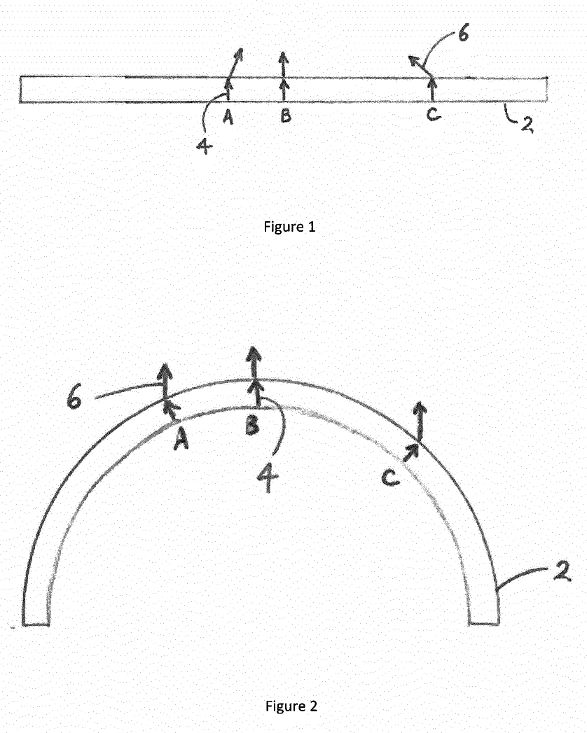

FIG. 1 illustrates an example of a light guide component according to an embodiment of the present invention, in a flat configuration.

FIG. 2 illustrates the light guide component of FIG. 1 flexed into a curved configuration for a curved display device;

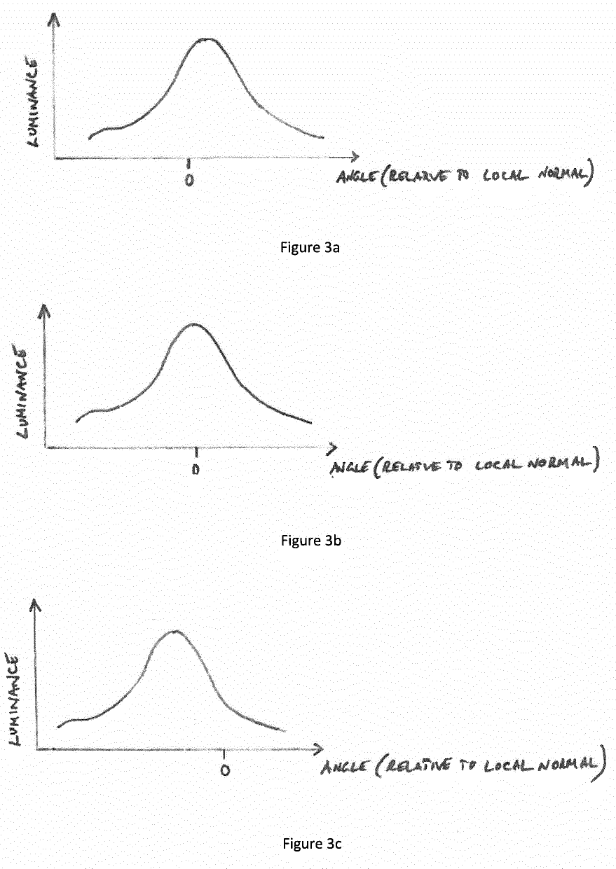

FIGS. 3a to 3c illustrate the output luminance distribution curve at different regions of the light guide component of FIGS. 1 and 2;

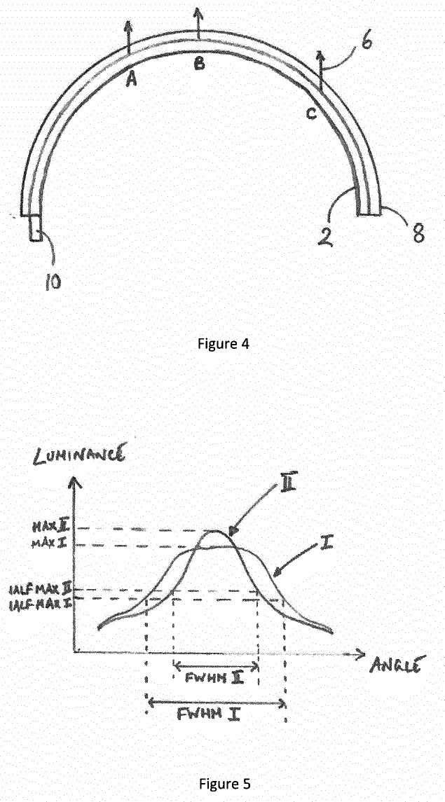

FIG. 4 illustrates the light guide component of FIGS. 1 and 2 combined in a curved configuration with a liquid crystal cell comprising electrical control circuitry; and

FIG. 5 illustrates a directionality enhancement effect in a different embodiment.

In one example embodiment, the technique is used for an organic liquid crystal display (OLCD) device, which comprise an array of organic thin-film-transistors (OTFTs); but the technique is also applicable to other kinds of liquid crystal display devices, and other kinds of display devices that use a backlight.

The embodiment described below is for a display device comprising a sidelight-type backlight in which one or more light sources are located outside of the display area, but the present invention is also applicable to, for example, display devices comprising backlight light sources within the display area.

Also, the embodiment described below is for a display device having a relatively simple curved configuration, but the present invention is also applicable to, for example, display devices having more complex curved configurations.

A light guide plate is used in sidelight-type display devices to direct and distribute light from one or more backlight sources outside the display area to the rear surface of an optical control component such as a liquid crystal cell) over the whole display area. The light guide plate may, for example, comprise a flexible sheet of plastic material (such as e.g. PMMA) having a substantially uniform thickness with microstructures defined in the surface adjacent to the optical control component (such as an LC cell).

Light from the one or more light sources outside the display area is directed by the light guide plate in a direction generally parallel to the plane of the light guide plate, and the microstructures defined in the surface adjacent the optical control component are configured to cause a portion of the light propagated along the light guide plate to be directed out of the light guide plate towards the optical control component (e.g. LC cell).

In conventional displays, the design of the microstructures is typically uniform across the whole area of the light guide plate—the directional properties of the optical output are typically uniform across the whole area of the light guide plate.

The directional properties of the optical output may be expressed in the form of a luminance distribution curve showing the relative luminance at different angles relative to the local normal. The local normal for any region of the light guide plate is the direction perpendicular to the plane of the light guide plate at that region. For a light guide plate in a flat configuration, the local normal is the same direction across the whole area of the light guide plate. For light guide plates in other configurations (e.g. curved configurations) the direction of the local normal varies across the area of the light guide plate relative a fixed reference direction.

For a conventional display, the light guide plate exhibits substantially the same luminance distribution curve at all regions across the entire display area. The angle (relative to the local normal) at which the luminance is highest (or the centre angle in the case of a substantially symmetrical luminance distribution curve) is substantially the same at all regions across the entire display area.

In this embodiment of the present invention, the microstructures defined in the surface of the light guide plate are intentionally designed to produce substantially different luminance distribution curves at different regions of the display area.

FIGS. 1 and 2 show how the direction of maximum luminance (relative to the respective local normal) may differ in one embodiment of the present invention. In FIGS. 1 and 2, the arrows 4 within the light guide plate 2 show the direction of the respective local normals, and the arrows 6 outside the light guide plate 2 show the direction of maximum luminance from the luminance distribution curve for the respective region of the light guide plate 2.

As shown in FIG. 1, the direction of maximum luminance (relative to the respective local normal) varies across the surface of the light guide plate 2. In the example of FIG. 1, the angle of maximum luminance (relative to the respective local normal) is about 0 degrees at one location B, and the angle of maximum luminance (relative to the respective local normal) is increasingly positive the further one moves away across the display area from location B in one direction, and is increasingly negative the further one moves away across the display area from location B in the opposite direction. Examples of luminance distribution curves for locations A, B and C are shown in FIGS. 3a, 3b and 3c, respectively. As shown in FIGS. 3a, 3b and 3c, the angle of maximum luminance (centre angle of the luminance distribution) is different for each of locations A, B and C relative to the respective local normal (angle 0 on the x-axis).

The change in the angle of maximum luminance across the surface of the light guide plate 2 is such that when the light guide plate is flexed into a curved configuration as shown in FIG. 2, the direction of maximum luminance (relative to a fixed reference direction such as the local normal at location B) is substantially the same across the whole area of the light guide plate 2 (or at least across the whole display area in the product display device comprising the light guide plate 2 and the optical control component 8 (e.g. LC cell)).

FIG. 4 shows the light guide plate 2 combined in the curved configuration with an LC cell 8 (as one example of an optical control component) and alight source 10 configured to couple light into the light guide plate 2 via a side edge of the light guide plate 2. The LC cell 8 comprises (a) a uniform thickness of LC material between two orthogonal polarisers and (b) active matrix circuitry for independently electrically controlling the transmission of the LC cell at each pixel region of the display device. The active matrix circuitry may, for example, comprise an array of organic transistor devices (such as an array of organic thin film transistor (OTFT) devices). OTFTs comprise an organic semiconductor (such as e.g. an organic polymer or small-molecule semiconductor) for the semiconductor channels.

In the embodiment described above, the microstructures defined in the surface of the light guide plate 2 are designed to achieve the desired variation in angle of maximum luminance (relative to the respective local normal) across the display area. In another embodiment, the desired variation in maximum luminance angle (relative to the respective local normal) across the display area is achieved by an additional component provided between the light guide plate 2 and the LC cell 8. The additional component may take the form of a flexible plastic film with microstructures defined in one more surfaces, which microstructures are designed to produce an optical output exhibiting the desired variation in maximum luminance angle (relative to the respective local normal) across the display area. In addition to the variation in maximum luminance angle across the display area, the additional component may also function to enhance the directionality of the output substantially uniformly across the display area. For example, for any region of the display area, the luminance distribution curve for the optical output of the additional component may exhibit a narrower (smaller) full width (FW) at the half maximum (HM) luminance value than the luminance distribution curve for the optical input of the additional component (e.g. optical output of the light guide plate). The FWHM defines the size of the range of angles at which the luminance is no less than half the maximum luminance. This directionality enhancement effect is illustrated in FIG. 5, in which curve I is the optical input for the additional component, and curve II is the optical output for the additional component.

As mentioned above, an embodiment of the present invention is described above for the example of a display device having the backlight light sources outside the display area. However, in one variation, the backlight light sources are provided within the display area, and an optical component is interposed between the backlight light sources and the control component (e.g. LC cell) to achieve the desired variation in maximum luminance angle (relative to the respective local normal) across the display area.

In addition to any modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. A display device, comprising:
a control component for electrically controlling an intensity of light transmitted therethrough from a backlight; and
an optical component between the backlight and the control component configured to convert input light exhibiting at least one directional property substantially uniformly across an area at an input side of the optical component to output light exhibiting a substantial variation in the at least one directional property across a corresponding area at an output side of the optical component.

2. The display device according to claim 1, wherein the at least one directional property comprises an angular luminance distribution relative to a local normal.

3. The display device according to claim 1, wherein the at least one directional property comprises a centre angle of the angular luminance distribution relative to the local normal, or an angle of maximum luminance relative to the local normal.

4. The display device according to claim 1, further configured to convert input light exhibiting a relative low directionality substantially uniformly across the area at the input side to output light exhibiting a relatively high directionality substantially uniformly across the corresponding area at an output side.

5. The display device according to claim 4, further configured to convert input light exhibiting a relative large full width at half maximum (FWHM) of the angular luminance distribution at the input side to output light exhibiting a relatively small full width at half maximum (FWHM) of the angular luminance distribution at the output side.

6. The display device according to claim 1, wherein at least the backlight and the control component are curved in a first region, and wherein the optical component is configured to convert input light exhibiting a substantially uniform luminance distribution relative to a local normal across an input side area corresponding to the first region to output light exhibiting a substantially uniform luminance distribution relative to a common reference direction, across a corresponding output side area corresponding to the first region.

7. A display device according to claim 1, wherein the optical component comprises microstructures defined in an output surface of a light guide, wherein optical action of the microstructures varies across the area of the output surface.

8. The display device according to claim 5, wherein at least the backlight and the control component are curved in a first region, and wherein the optical component is configured to convert input light exhibiting a substantially uniform luminance distribution relative to a local normal across an input side area corresponding to the first region to output light exhibiting a substantially uniform luminance distribution relative to a common reference direction, across a corresponding output side area corresponding to the first region.
